(19) United States
(12) Patent Application Publication
(10) Pub. No.: US 2018/0046150 A1
(43) Pub. Date: Feb. 15, 2018

(54) OPERATION MANAGEMENT SYSTEM HAVING SENSOR AND MACHINE LEARNING UNIT

(71) Applicant: Fanuc Corporation, Yamanashi (JP)

(72) Inventor: Masafumi OOBA, Yamanashi (JP)

(21) Appl. No.: 15/666,716

(22) Filed: Aug. 2, 2017

(30) Foreign Application Priority Data
Aug. 9, 2016 (JP) 2016-156729

(51) Int. Cl. G05B 13/02

(52) U.S. Cl. CPC G05B 13/027

(57) ABSTRACT

An operation management system includes a sensor for obtaining data on an operator and a cell control device connected to the sensor. The cell control device includes a sensor management unit for managing information from the sensor; an operator monitor unit for monitoring at least one of the motion amount and condition amount of the operator; a learning unit for learning at least one of the degrees of fatigue, proficiency, and interest of the operator; and a notification management unit that transmits condition information including at least one of the degrees of fatigue, proficiency, and interest of the operator, when receiving a condition notification request from a host management unit, and that receives an operation details change notification and transfers the operation details change notification to the operator, or that transmits the condition information to the operator, when receiving a condition notification request from the operator.

This application is a new U.S. patent application that claims benefit of JP 2016-156729 filed on Aug. 9, 2016, the content of 2016-156729 is incorporated herein by reference.

### BACKGROUND OF THE INVENTION

### 1. Field of the Invention

The present invention relates to an operation management system for operators, and more specifically relates to an operation management system having at least one sensor and a machine learning unit.

### 2. Description of Related Art

Vending machines that change merchandise to be displayed in an active manner based on the ages and facial expressions of users have been widespread in recent years. This technique, called “human vision”, which detects a human and uses information on the human, has been actively studied and developed in recent years.

For example, a method in which a user's physiological condition and action are determined and an environment of the user's situated place is controlled and managed in order to facilitate the user's recovery from fatigue and improvement in operation efficiency is reported (for example, Japanese Unexamined Patent Publication (Kokai) No. 2007-151933, hereinafter referred to as “patent document 1”). In patent document 1, since measured values of the user's action and/or physiological condition are compared with arbitrary reference values, there is a problem that the determination results have a wide range of variations depending on the set reference values.

A method for precisely measuring a user's fatigue while typing text into a computer is also reported (for example, Japanese Unexamined Patent Publication (Kokai) No. 2005-71250, hereinafter referred to as “patent document 2”). In patent document 2, since the degree of fatigue in the typing operation is inputted subjectively, a fatigue condition cannot be objectively determined.

A method in which the degree of an operator's fatigue is objectively quantified reflecting differences in individual operators, in order to prevent an accident and a deterioration in operational quality due to fatigue is also reported (for example, Japanese Unexamined Patent Publication (Kokai) No. 2009-226057, hereinafter referred to as “patent document 3”). In patent document 3, since each operator's operation profile data is obtained on an individual basis, the profile data has to be newly obtained whenever the operator changes, thus requiring man-hours. Moreover, the data becomes enormous in size, and therefore it is necessary to configure an expensive data processing system to manage the enormous amount of data.

### SUMMARY OF THE INVENTION

The present invention aims at providing an operation management system that can prevent a reduction in productivity owing to fatigue, owing to differences in proficiency, or owing to less interest in engaging operation.

An operation management system according to an embodiment of the present invention includes at least one sensor for obtaining data on at least one operator who performs operation on a plurality of workpieces; and a cell control device communicatably connected to the sensor. The cell control device includes a sensor management unit for, upon receiving information from the sensor, merging and managing the received information; an operator monitor unit for monitoring at least one of the motion amount and the condition amount of the operator included in the information from the sensor received by the sensor management unit; a learning unit for learning at least one of the degree of fatigue, the degree of proficiency, and the degree of interest of the operator based on the motion amount and the condition amount; and a notification management unit that, upon receiving a condition notification request from a host management unit, transmits condition information including at least one of the degree of fatigue, the degree of proficiency, and the degree of interest of each operator to the host management unit, and that, upon receiving an operation details change notification from the host management unit, transfers the operation details change notification to the operator, or that, upon receiving a condition notification request from the operator, transmits the condition information including at least one of the degree of fatigue, the degree of proficiency, and the degree of interest of the operator to the operator.

### BRIEF DESCRIPTION OF THE DRAWINGS

The objects, features, and advantages of the present invention will become more apparent from the following detailed description of embodiments, along with accompanying drawings. In the accompanying drawings:

FIG. 1 is a configuration diagram of an operation management system according to an embodiment of the present invention;

FIG. 2 is a block diagram of an embodiment of a learning unit (unsupervised) included in the operation management system according to the embodiment of the present invention;

FIG. 3 is a block diagram of another embodiment of the learning unit (supervised) included in the operation management system according to the embodiment of the present invention;

FIG. 4 is a schematic diagram of a model of a neuron;

FIG. 5 is a schematic diagram of a three-layer neural network constituted of a combination of the neurons shown in FIG. 4;

FIG. 6 is a flowchart that explains an example of the operation of the learning unit (unsupervised) in the operation management system according to the embodiment of the present invention; and

FIG. 7 is a flowchart that explains an example of notifying an operator and an operation supervisor of the condition of the operator using a learning result in the operation management system according to the embodiment of the present invention.

### DETAILED DESCRIPTION OF THE INVENTION

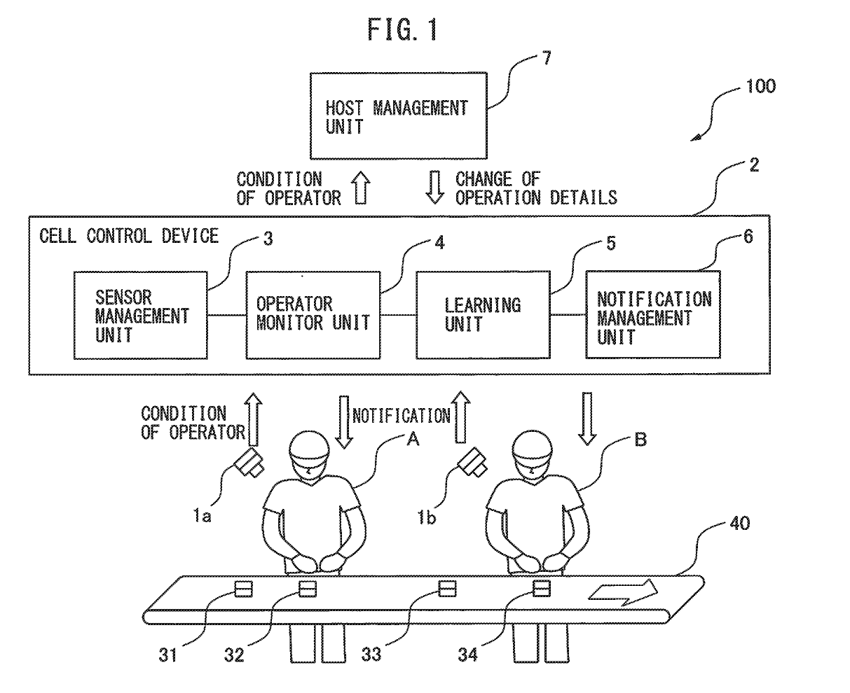

An operation management system according to an embodiment of the present invention will be first described. FIG. 1 is a configuration diagram of the operation management system according to the embodiment of the present invention. An operation management system 100 according to a first embodiment of the present invention has at least one sensor (1a, 1b) and a cell control device 2.

The sensor (1a, 1b) obtains data on at least one operator (A, B) who performs operation on a plurality of workpieces (31 to 34). FIG. 1 shows an example in which the operation management system according to the embodiment of the present invention is applied to two operators A and B. However, the number of operators is not limited thereto, and may be one or three or more. Furthermore, FIG. 1 shows an example of providing one sensor for one operator. However, not limited to this example, one sensor may monitor a plurality of operators, or a plurality of sensors may monitor one operator.

In the example of FIG. 1, a first sensor 1a detects data on the operator A, while a second sensor 1b detects data on the operator B. In this embodiment, the operators A and B perform operation on the workpieces 31 to 34 conveyed on a conveyor 40. However, the operation is not limited thereto, and the operators A and B may perform other operations.

The sensor (1a, 1b) preferably detects the body motion, a change in the posture, the facial expression, and the like of the operator. The sensor (1a, 1b) preferably has the function of measuring an operation time from the start to the end of the sequential operation, which is repeatedly performed by the operator. The sensor (1a, 1b) preferably has the function of measuring the degree of accomplishment of the operation performed by the operator. The sensor (1a, 1b) preferably has the function of counting the number of defective workpieces produced by the operation performed by the operator. When the plurality of operators are present, the sensor (1a, 1b) preferably has the function of measuring the difference in an operation amount between the operators. The sensor (1a, 1b) also preferably has the function of measuring the motion amount of the operator.

The cell control device 2 is communicatably connected to the sensor (1a, 1b). The cell control device 2 is connected to the sensor (1a, 1b) wiredly or wirelessly. The cell control device 2 includes a sensor management unit 3, an operator monitor unit 4, a learning unit (machine learning unit) 5, and a notification management unit 6.

The sensor management unit 3 receives information from the sensor (1a, 1b), and merges and manages the received information.

The operator monitor unit 4 monitors at least one of the motion amount and the condition amount of the operator (A, B) included in the information from the sensor (1a, 1b) received by the sensor management unit 3. The “motion amount” of the operator refers to information to which, for example, the body motion of the operator who is performing the specific operation on the work is quantified. The “condition amount” of the operator refers to information to which, for example, the physical condition, the mental condition, the degree of concentration at the operation, or the like of the operator, which is estimated from the facial expression of the operator, is quantified. The operator monitor unit 4 may monitor an operation time from the start to the end of the sequential operation, which is repeatedly performed by the at least one operator (A, B). The operator monitor unit 4 may monitor the degree of accomplishment of the operation performed by the operator (A, B). The operator monitor unit 4 may monitor the number of defective workpieces produced by the operation performed by the operator (A, B). When the plurality of operators are present, the operator monitor unit 4 may monitor the difference in the operation amount between the operators. The operator monitor unit 4 may monitor the motion amount of the operator. As described above, the operator monitor unit 4 preferably monitors at least one of the operation time, the degree of accomplishment of the operation, the number of defective workpieces, the difference in the operation amount, and the motion amount.

The learning unit (machine learning unit) 5 learns at least one of the degree of fatigue, the degree of proficiency, and the degree of interest of the operator based on the motion amount and the condition amount of the operator. The configuration of the learning unit 5 will be described later. The relationship between the motion amount and condition amount of the operator and the degree of fatigue, the degree of proficiency, and the degree of interest of the operator will now be briefly described. For example, when the motion amount and the condition amount of the operator decrease with a lapse of the operation time, the degree of fatigue of the operator is estimated to be increasing. When the operation amount of a specific operator per unit time is greater than the operation amounts of the other operators, and if the motion amount of the operator is greater than the motion amounts of the other operators, the degree of proficiency of the operator is estimated to be high. When the motion amount of a specific operator remains high from the beginning of the operation, the degree of interest of the operator in the operation is estimated to be high.

Upon receiving a condition notification request from a host management unit 7, the notification management unit 6 transmits condition information including at least one of the degree of fatigue, the degree of proficiency, and the degree of interest of each operator (A or B) to the host management unit 7. Upon receiving an operation details change notification from the host management unit 7, the notification management unit 6 transfers the operation details change notification to at least one of the operators (A and B). Upon receiving a condition notification request from at least one of the operators (A and B), the notification management unit 6 transmits condition information including at least one of the degree of fatigue, the degree of proficiency, and the degree of interest of the operator to the operator.

For example, the cell control device 2 sequentially obtains the condition amounts of the operators (A and B), and the learning unit 5 of the cell control device 2 extracts information (the degree of fatigue, the degree of proficiency, and the degree of interest) of which the operators (A and B) are unaware from the obtained information. The cell control device 2 notifies the host management unit 7 of the extracted information.

When an operator having a high degree of fatigue is found, the host management unit 7 transmits an operation details change notification to the cell control device 2 to give him/her a break and put another operator therein. The cell control device 2 provides the received operation details change notification for the operators and an operation supervisor.

When an operator having a low degree of proficiency is found, the host management unit 7 transmits an operation details change notification to the cell control device 2 to switch him/her with another operator having a high degree of proficiency. The cell control device 2 provides the received operation details change notification for the operators and the operation supervisor.

When an operator having a low degree of interest is found, the host management unit 7 transmits an operation details change notification to the cell control device 2 to switch him/her with another operator having a high degree of interest. The cell control device 2 provides the received operation details change notification for the operators and the operation supervisor.

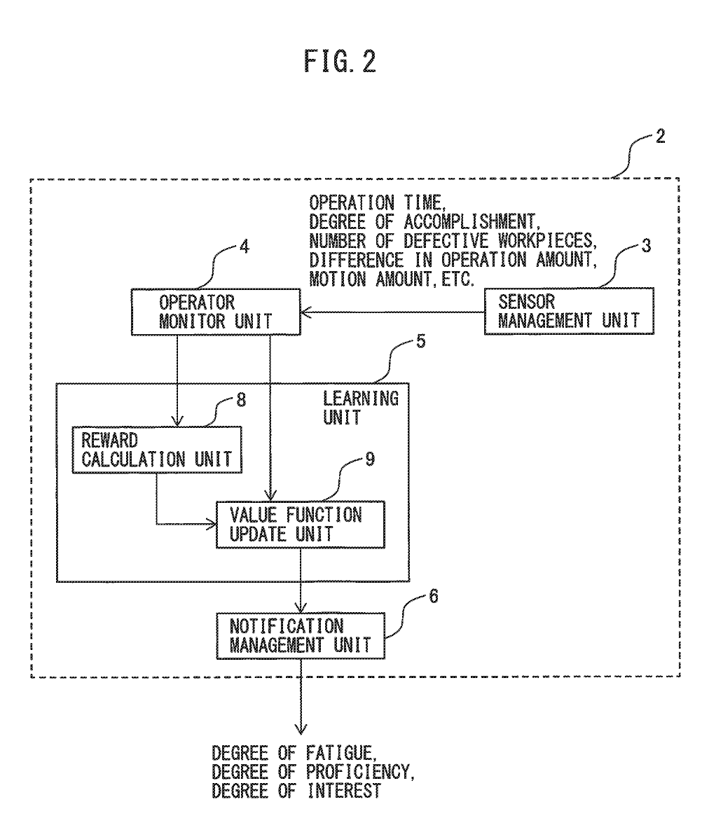

Next, unsupervised learning by the learning unit of the operation management system according to the embodiment of the present invention will be described. FIG. 2 is a block diagram of an embodiment of the cell control device 2 included in the operation management system according to the embodiment of the present invention. In FIG. 2, “reinforcement learning (Q learning)” is applied to the cell control device 2. To perform Q learning, the cell control device 2 according to the embodiment includes the sensor management unit 3, the operator monitor unit 4, the learning unit 5, and the notification management unit 6. However, the machine learning algorithm applied to the present invention is not limited to Q learning.

As shown in FIG. 2, the learning unit 5 includes a reward calculation unit 8 and a value function update unit 9. The operator monitor unit 4 monitors the condition amount of at least one of the operators (A and B). To be more specific, for example, at least one of the following items (1) to (5) is monitored.

(1) an operation time from the start to the end of sequential operation repeatedly performed by the operator (A or B)

(2) the degree of accomplishment of operation performed by the operator (A or B)

(3) the number of defective workpieces produced by operation performed by the operator (A or B)

(4) the difference in an operation amount between operators, when the number of the operators is two or more

(5) the motion amount of the operator

The reward calculation unit 8 calculates a reward based on an output of the operator monitor unit 4. For example, when the motion amount of the operator has not increased, the reward decreases (negative reward). When the motion amount of the operator has increased and the operation time has decreased, the reward increases (positive reward). When the motion amount of the operator has increased and the operation time has not decreased, no reward is applied.

The value function update unit 9 updates a value function, which determines the values of the degree of fatigue, the degree of proficiency, and the degree of interest of the operator (A or B) based on an output of the operator monitor unit 4 and an output of the reward calculation unit 8, in accordance with the reward.

The degree of fatigue, the degree of proficiency, and the degree of interest of the operator (A or B) can be detected based on the operation time, the degree of accomplishment, the number of defective workpieces, the difference in the operation amount, the motion amount, and the like of the operator inputted from the sensor management unit 3.

As the degree of accomplishment of operation performed by the operator (A or B), there is, for example, the ratio between the number of operated workpieces and the target number of workpieces to be operated by the operator.

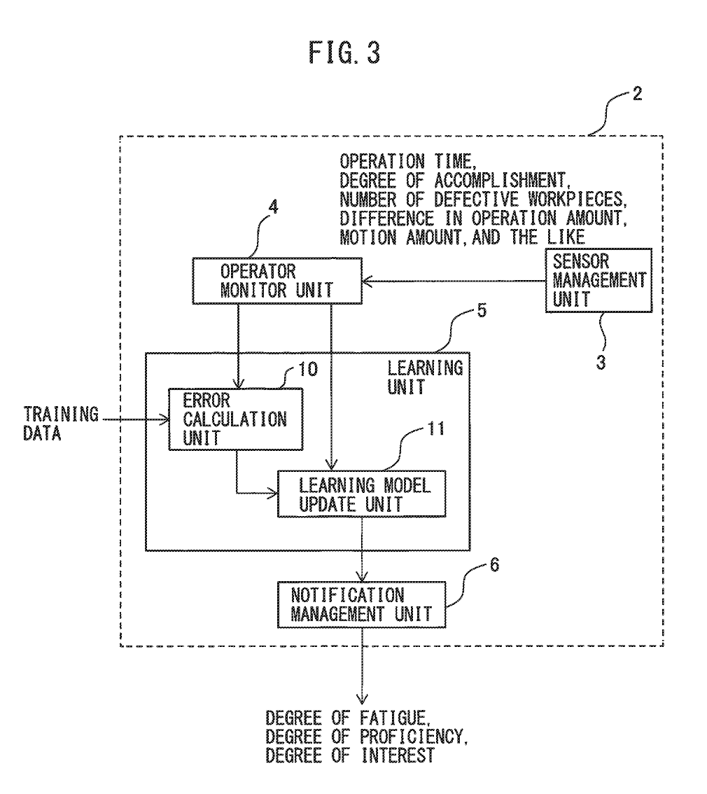

Next, supervised learning by the learning unit of the operation management system according to the embodiment of the present invention will be described. FIG. 3 is a block diagram of another embodiment of the cell control device 2 included in the operation management system according to the embodiment of the present invention to which supervised learning is applied. When comparing FIGS. 2 and 3, the difference between the cell control device 2 of FIG. 3 to which supervised learning is applied and the cell control device 2 of FIG. 2 to which Q learning (reinforcement learning) is applied is that training data is provided for the cell control device 2 of FIG. 3.

As shown in FIG. 3, the cell control device 2 to which supervised learning is applied includes the sensor management unit 3, the operator monitor unit 4, the learning unit 5, and the notification management unit 6. The learning unit 5 includes an error calculation unit 10 and a learning model update unit 11. The error calculation unit 10 calculates an error based on an output of the operator monitor unit 4 and inputted training data. The learning model update unit 11 updates a learning model, which determines an error in the degree of fatigue, the degree of proficiency, and the degree of interest of at least one operator based on the output of the operator monitor unit 4 and an output of the error calculation unit 10.

The error calculation unit 10 and the learning model update unit 11 correspond to the reward calculation unit 8 and the value function update unit 9, respectively, of the cell control device 2 of FIG. 2, to which Q learning is applied. However, the training data is inputted from outside to the error calculation unit 10 of this embodiment. The learning model update unit 11 updates the learning model so as to reduce the difference between the training data and the learning model (error model).

In other words, upon receiving the output of the operator monitor unit 4 and the training data, the error calculation unit 10 calculates an error between result (labeled) data and the learning model included in the learning unit 5. When the same operator performs the same operation, for example, labeled data obtained up until the day prior to a certain day when operation is actually performed may be held, and the labeled data may be supplied on the certain day as the training data to the error calculation unit 10.

The error calculation unit 10 of the cell control device 2 may be supplied with data obtained by simulation or the like performed outside the operation management system, or labeled data on another operation management system as the training data through a memory card or a communication line. Furthermore, the training data (labeled data) may be held in, for example, a nonvolatile memory (not shown) such as a flash memory contained in the learning unit 5, and the labeled data held in the nonvolatile memory may be used as in the learning unit 5.

Next, reinforcement learning will be described. The following is problem settings of reinforcement learning.
The cell control device monitors an environmental state and determines an action.
An environment changes in accordance with some rule, and the action itself may exert a change in the environment.
A reward signal returns whenever exerting the action.
What is desired to be maximized is the sum of discount rewards in the future.
Learning is started in a state that the result of the action is not known at all or is incompletely known. In other words, the cell control device can obtain the result as data only after executing the action in a practical manner. Accordingly, it is necessary to search for an optimal action through trial and error.
Setting a pre-learning state (by the above-described supervised learning algorithm or an inverse reinforcement learning algorithm) as an initial state, learning may be started from a suitable start point, like the action of a human being.

Reinforcement learning refers to learning of an appropriate action based on interaction of the action with the environment by learning the action as well as determination and classification, in other words, learning to maximize a reward to be obtained in the future. The following describes Q learning by way of example, but reinforcement learning is not limited to Q learning.

Q learning is an algorithm for learning the value Q(s,a) of choosing an action “a” in certain environmental state s. In other words, in the certain environmental state s, the action “a” having the highest value Q(s,a) is chosen as an optimal action. However, at first, the correct value Q(s,a) as to a combination of the state s and the action “a” is not known at all. Thus, an agent (action subject) chooses various actions a in the certain environmental state s, and receives rewards for the actions a. The agent is thereby learning a choice of a better action, i.e., the correct value Q(s,a).

Furthermore, to maximize the sum of rewards obtained in the future as the results of actions, Q learning purports to have Q(s,a)=E[Σ(γ)rₜ] in the end. Since an expected value, which occurs when a state changes with an optimal action, is not known, learning is being performed while searching. The update of the value Q(s,a) is expressed as, for example, the following equation (1):

$$Q ( {s}_{t} , {a}_{t} ) ← Q ( {s}_{t} , {a}_{t} ) + α ( {r}_{t + 1} + γ {max}_{a} Q ( {s}_{t + 1} , a ) - Q ( {s}_{t} , {a}_{t} ) ) \qquad ( 1 )$$

In the above equation (1), sₜ represents an environmental state at a time t, and at represents an action at the time t. The state changes to sₜ₊₁ by taking the action aₜ. rₜ₊₁ represents a reward received after the change of the state at that time. A term having max is the product of a Q value, when choosing an action “a” having the highest Q value that has been known at that time in the state of sₜ₊₁, and γ. γ is a parameter of 0<γ≦1 called discount rate. α is a learning factor in the range of 0≦α≦1.

The equation (1) indicates an algorithm to update the evaluation value Q(sₜ,aₜ) of the action aₜ in the state sₜ based on the reward rₜ₊₁ received as the result of the trial aₜ. In other words, Q(sₜ,aₜ) is increased when the evaluation value Q(sₜ₊₁,max aₜ₊₁) of an optimal action max a in the next state that is derived from the reward rₜ₊₁ and the action “a” is higher than the evaluation value Q(sₜ,aₜ) of the action “a” in the state s. On the other hand, Q(sₜ,aₜ) is decreased when the evaluation value Q(sₜ₊₁,max aₜ₊₁) is lower than the evaluation value Q(sₜ,aₜ). In fact, the value of an action in a state is approximated to the value of the best action in the next state that is brought by a reward received immediately as a result and the action.

To express Q(s,a) in computers, Q(s,a) values of every action pair (s,a) may be held in form of a table, or a function to approximate Q(s,a) may be prepared. In the latter case, the above equation (1) is obtained by adjusting parameters of an approximation function by a stochastic gradient descent method and the like. As the approximation function, a neural network is usable as described later.

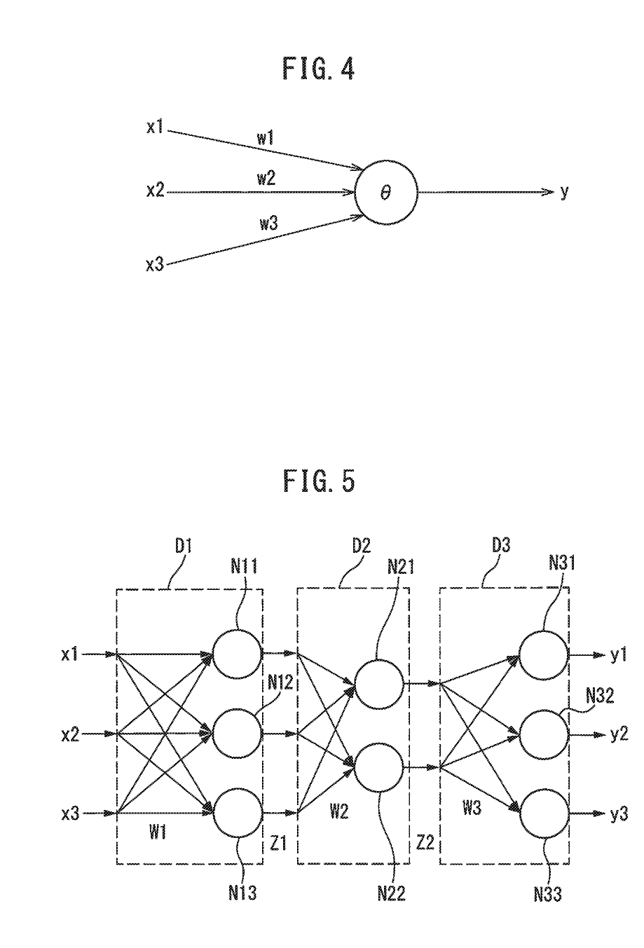

As an approximation algorithm of a value function in reinforcement learning, a neural network is usable. FIG. 4 is a schematic diagram of a model of a neuron, and FIG. 5 is a schematic diagram of a three-layer neural network constituted of a combination of the neurons shown in FIG. 4. The neural network is constituted of, for example, an arithmetic device, a memory, and the like that imitate the model of the neuron shown in FIG. 4.

As shown in FIG. 4, the neuron outputs an output (result) y in response to a plurality of inputs x (as an example, inputs x1 to x3 in FIG. 4). Each input x (x1, x2, or x3) is multiplied by a weight w (w1, w2, or w3) corresponding to the input x. Thus, the neuron outputs the result y expressed as the following equation (2). Note that, all of the input x, result y, and weight w are vectors. In the following equation (2), θ is a bias, and fₖ is an activation function.

y=fₖ(Σᵢ₌₁ⁿxᵢwᵢ−θ) (2)

Referring to FIG. 5, the three-layer neural network, which is constituted of a combination of the neurons shown in FIG. 4, will be described. A plurality of inputs x (e.g., inputs x1 to x3) are inputted from the left of the neural network, and results y (e.g., results y1 to y3) are outputted from the right thereof. To be more specific, the inputs x1 to x3 are inputted to each of three neurons N11 to N13, while being multiplied by corresponding weights. The weights applied to the inputs are collectively indicated by W1.

The neurons N11 to N13 output z11 to z13, respectively. In FIG. 5, z11 to z13 are collectively indicated by a feature vector Z1, which is regarded as a vector that extracts a feature amount from the input vector. The feature vector Z1 is between the weight W1 and a weight W2. The vectors z11 to z13 are inputted to each of two neurons N21 and N22, while being multiplied by corresponding weights. The weights applied to the feature vectors are collectively indicated by W2.

The neurons N21 and N22 output z21 and z22, respectively. In FIG. 5, z21 and z22 are collectively indicated by a feature vector Z2. The feature vector Z2 is between the weight W2 and a weight W3. The vectors z21 and z22 are inputted to each of three neurons N31 to N33, while being multiplied by corresponding weights. The weights applied to the feature vectors are collectively indicated by W3.

Finally, the neurons N31 to N33 output the results y1 to y3, respectively. The operation of the neural network has a learning mode and a value prediction mode. For example, in the learning mode, the weight W is learned using a learning data set. In the value prediction mode, an action of the numerical control device is determined using the parameters learned in the learning mode. The term “prediction” is used for the sake of convenience, but various tasks including detection, classification, inference, and the like can be made as a matter of course.

The agent may immediately learn data that is obtained by actual operation of the cell control device in the value prediction mode, and reflect the learning result in the next action (on-line learning). The agent may collectively learn a data group collected in advance, and continue performing a detection mode thereafter using the parameters (batch learning). As an intermediate means, the agent may perform the learning mode whenever a certain amount of data is accumulated.

The weights W1 to W3 can be learned using an error back propagation algorithm (backpropagation algorithm). Error information enters from the right and propagates to the left. In the error back propagation algorithm, the weights of each neuron are adjusted (learned) so as to minimize the difference between an output y and an actual output y (supervisor) in response to an input x. The neural network may have an increased number of layers, e.g., more than three layers (called deep learning). An arithmetic unit that performs input feature extraction in stages and regression of a result may be automatically acquired from only supervisor data.

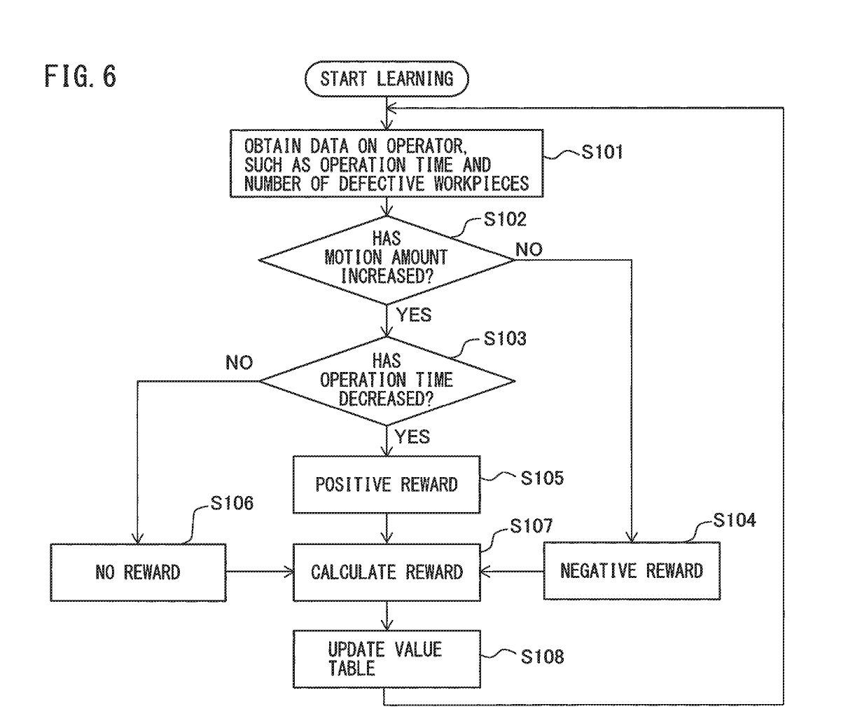

Next, the operation of the cell control device according to the embodiment of the present invention will be described. FIG. 6 is a flowchart that explains an example of the operation of the learning unit (unsupervised) in the operation management system according to the embodiment of the present invention. By way of example, the operator monitor unit 4 obtains information on an operation time, the number of defective workpieces a difference in an operation amount, a motion amount, and the like from the sensor management unit 3. As shown in FIG. 6, upon starting learning, in step S101, the operator monitor unit 4 obtains data on an operation time, the number of defective workpieces, and the like of an operator from the sensor management unit 3.

Next, in step S102, the operator monitor unit 4 determines whether or not the motion amount of the operator has increased. When the motion amount of the operator is determined to have increased, it is determined in step S103 whether or not the operation time has decreased.

On the other hand, when the motion amount of the operator is determined to be the same or have decreased, the reward calculation unit 8 establishes a negative reward in step S104. The reason why the negative reward is established is that the stay or decrease of the motion amount of the operator is considered to be caused by a reduction in the operation efficiency of the operator.

When the operation time is determined to have decreased in step S103, the reward calculation unit 8 establishes a positive reward in step S105. On the other hand, when the operation time is not determined to have decreased, the reward calculation unit 8 establishes no reward (zero reward) in step S106. In step S107, the reward calculation unit 8 calculates a reward based on the result of “negative reward”, “positive reward”, or “no reward” of step S104, S105, or S106. Next, in step S108, the value function update unit 9 updates an action value table. Thereafter the operation returns to step S101 to repeat the same operation. Therefore, the operation efficiency of at least one operator can be optimized.

In steps S104, S105, and S106, the values (amounts) of the “negative reward”, “positive reward”, and “no reward” are appropriately determined in accordance with various conditions, as a matter of course.

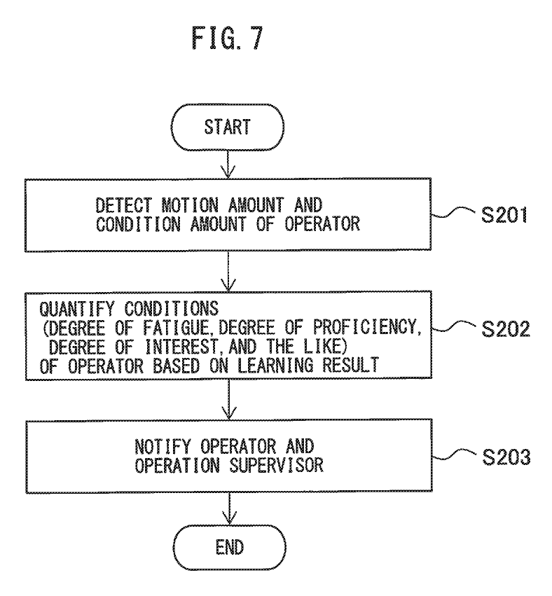

Next, the operation of the operation management system according to the embodiment of the present invention will be described. FIG. 7 is a flowchart that explains an example of notifying an operator and an operation supervisor of the condition of the operator using a machine learning result in the operation management system according to the embodiment of the present invention. First, a sensor (1a, 1b) detects the motion amount and the condition amount of an operator (A, B) in step S201 (see FIG. 1).

Next, in step S202, the notification management unit 6 quantifies the conditions of the operator based on a learning result. What to quantify is the degree of fatigue, the degree of proficiency, the degree of interest, and the like of the operator, but these are simply examples and not limited thereto.

The quantification and optimization of the degree of fatigue, the degree of proficiency, the degree of interest, and the like are performed in accordance with the flowchart shown in FIG. 6. After the degree of fatigue, the degree of proficiency, and the degree of interest that can optimize the operation efficiency of the operator are determined as a result of learning, the learning unit 5 notifies the notification management unit 6 of these values.

Next, in step S203, the notification management unit 6 notifies the operator and an operation supervisor of a change of operation details. The cell control device 2 transmits data on the operator to the host management unit 7. The cell control device 2 receives an operation details change notification from the host management unit 7, and transfers the operation details change notification to the operator and the operation supervisor. However, not limited to this example, the cell control device 2 may change operation details, and transmit the details to the operator or the operation supervisor. When the data to be transmitted from the cell control device 2 to the host management unit 7 is large in size, the cell control device 2 has to wait for a long time to receive the operation details change notification from the host management unit 7. Therefore, the cell control device 2 preferably has the function of changing operation details.

As described above, the operation management system according to the embodiment of the present invention collects operation times, body motions, facial expressions, and the like of which operators are unaware. Therefore, it is possible to detect such a condition under which the operator cannot concentrate on an operation owing to, e.g., anxiety, even though he/she is in good health.

Although health data tends to vary relatively widely from person to person, operation times, body motions, facial expressions, and the like, which the operation management system according to the embodiment of the present invention deals with, are likely to be estimated objectively and are insusceptible to determination errors depending on individual differences.

The operation management system according to the embodiment of the present invention notifies not only the host management unit but also the operator of information, so as to make use of the information in improving operation details.

As described above, the operation management system according to the embodiment of the present invention measures the body motions, posture changes, facial expressions, and the like of operators who work in a factory using the sensors, and sequentially obtains the data through the cell control device. The operation management system quantifies information (the degree of fatigue, the degree of proficiency, and the degree of interest) of which the operators are unaware by a machine learning algorithm, and uses the information to improve productivity.

The operation management system according to the embodiment of the present invention allows for providing an operation management system that can prevent a reduction in productivity owing to fatigue, owing to difference in proficiency, or owing to less interest in engaging operation.

What is claimed is:

1. An operation management system comprising:
at least one sensor for obtaining data on at least one operator who performs operations on a plurality of workpieces; and
a cell control device communicatably connected to the at least one sensor, wherein
the cell control device includes:
a sensor management unit for, upon receiving information from the at least one sensor, merging and managing the received information;
an operator monitor unit for monitoring at least one of the motion amount and the condition amount of the operator included in the information from the at least one sensor received by the sensor management unit;
a learning unit for learning at least one of the degree of fatigue, the degree of proficiency, and the degree of interest of the operator based on the motion amount and the condition amount; and
a notification management unit for, upon receiving a condition notification request from a host management unit, transmitting condition information including at least one of the degree of fatigue, the degree of proficiency, and the degree of interest of each of the at least one operator to the host management unit, and
the notification management unit for, upon receiving an operation details change notification from the host management unit, transferring the operation details change notification to the at least one operator, or
the notification management unit for, upon receiving a condition notification request from the at least one operator, transmitting condition information including at least one of the degree of fatigue, the degree of proficiency, and the degree of interest of the operator to the operator.

2. The operation management system according to claim 1, wherein the operator monitor unit monitors at least one of:
an operation time from the start to the end of the sequential operation repeatedly performed by the at least one operator;
the degree of accomplishment of the operation performed by the at least one operator;
the number of defective workpieces produced by the operation performed by the at least one operator;
the difference in an operation amount between operators, when the plurality of operators are present; and
the motion amount of the operator.

3. The operation management system according to claim 1, wherein the learning unit includes:
a reward calculation unit for calculating a reward based on an output from the operator monitor unit; and
a value function update unit for updating a value function for determining the values of the degree of fatigue, the degree of proficiency, and the degree of interest of the at least one operator based on the output of the operator monitor unit and an output of the reward calculation unit, in accordance with the reward.

4. The operation management system according to claim 1, wherein the learning unit includes:
an error calculation unit for calculating an error based on the output of the operator monitor unit and inputted training data; and
a learning model update unit for updating a learning model for determining an error in the degree of fatigue, the degree of proficiency, and the degree of interest of the at least one operator based on the output of the operator monitor unit and an output of the error calculation unit.

5. The operation management system according to claim 1, wherein the learning unit includes a neural network.
